(19) United States
(12) Patent Application Publication
(10) Pub. No.: US 2023/0381055 A1
(43) Pub. Date: Nov. 30, 2023

(54) MOBILE MASSAGE DEVICE AND METHOD FOR CONTROLLING SAME

(71) Applicant: Hong Tae SEO, Gyeonggi-do (KR)

(72) Inventor: Hong Tae SEO, Gyeonggi-do (KR)

(21) Appl. No.: 18/232,832

(22) Filed: Aug. 11, 2023

Related U.S. Application Data
(63) Continuation of application No. PCT/KR2021/003359, filed on Mar. 18, 2021.

(51) Int. Cl. A61H 7/00; A61H 23/00

(52) U.S. Cl. CPC A61H 7/005; A61H 7/007; A61H 23/006; A61H 2201/501

(57) ABSTRACT

Disclosed herein is a mobile massage device including a moving part configured to move the mobile massage device while a position of the mobile massage device is changed, a connector directly mechanically coupled to the moving part, and a massage part that is directly mechanically coupled to the connector and performs a massage service by interlocking with the moving part. Disclosed herein are a mobile massage device and a method for controlling thereof. The control method of the mobile massage device may include massage preparation operation (a) before performing a massage with the mobile massage device, massage part operation (b) of performing the massage, moving part operation (c) of moving the mobile massage device, remote control operation (d) of controlling the mobile massage device from the outside of the mobile massage device, and an operation of determining optimal massage using one or more among operations (a) to (d).

### CROSS-REFERENCE TO RELATED APPLICATION

This application is a US Bypass Continuation Application of International Application No. PCT/KR2021/003359, filed on Mar. 18, 2021, the disclosure of which is incorporated herein by reference in its entirety.

### BACKGROUND

### Technical Field

The present invention relates to a mobile massage device which can provide mobile massage to a user's body.

### Background Art

As the composition of society becomes more diverse and people's lives become more complicated, the tendency to complain of physical and mental fatigue in society and at home increases, and the massage industry is steadily growing for various purposes such as fatigue recovery, beauty, obesity management, body shape control, and the like. To this end, both users and related markets are expanding in the form of massage shops, skin care shops, obesity management shops, and the like. As the demand for massage rapidly increases, the demand and supply of massage devices which can conveniently provide massage at home or company welfare facilities instead of visiting related commercial facilities due to time, space, cost, and the like reasons are also rapidly increasing. Typical massage devices include manual and electric products such as massage chairs, massage rods, massage pads, massage robots, and the like. In particular, massage chairs or massage robots are used in the form of implementing massage through a mechanism using a plurality of motors.

The massage devices perform motions similar to motions of person's hands through movements of a motor and a machine. In the case of a massage rod or a massage device for shoulder and neck massages, a person should hold the rod or device with his or her hands and operates the rod or device. Regarding the massage device described above, Korean Patent Registration No. 10-1682399 (hereinafter referred to as “Patent Document 1”) discloses a wireless hand massage device which can be held by hand and can massage.

Specifically, the content of providing a massage service including a driving part, a battery, an ascending and descending part, a wind generating part, and the like to a user is disclosed in Patent Document 1.

However, the massage device of Patent Document 1 is inconvenient for a person to hold by hand and press against a portion requiring massage.

Regarding another type of a massage device, Korean Patent Registration No. 10-1563869 (hereinafter referred to as “Patent Document 2”) discloses a massage chair and a method for controlling it, in which a person can sit to get a massage on his or her back, hands, and legs.

Specifically, the content of providing a massage service including a backrest, a headrest, an armrest, a leg-rest, a motor, a driving part of a treatment body, and the like to a user is disclosed in Patent Document 2.

However, the massage device of Patent Document 2 is bulky, expensive, and inconvenient because it applies enough mechanical pressure to cause pain during massage.

Regarding still another type of a massage device, Korean Patent Registration No. 10-2055313 (hereinafter referred to as “Patent Document 3”) discloses a massage device in the form of a robot system, which can perform massage using a plurality of articulated arms.

Specifically, the content of providing a massage service including a support body on which a person is placed, a plurality of articulated arms with a plurality of degrees of freedom, and the like to a user is disclosed in Patent Document 3.

However, in the case of a massage robot using an articulated arm, the price is high, and because the volume is large, there is an inconvenience that it requires much space.

### SUMMARY

### Technical Problem

The present invention is directed to providing a mobile massage device and a method for controlling same, which can provide mobile massage to a user's body.

The problems to be solved by the present invention are not limited to the above-described problem, and other problems not mentioned can be clearly understood by those skilled in the art from the following description.

### Technical Solution

### First Embodiment of Mobile Massage Device

A mobile massage device according to a first embodiment of the present invention includes a moving part configured to move the mobile massage device while a position of the mobile massage device is changed, and a massage part that is directly mechanically coupled to the moving part and performs a massage service by interlocking with the moving part.

A control method of the mobile massage device according to the first embodiment of the present invention includes massage preparation operation (a) of checking power, signals, sensors, and a device state before performing massage with the mobile massage device, massage part operation (b) of performing massage when massage preparation is appropriate, moving part operation (c) of moving the mobile massage device when the massage preparation is appropriate, remote control operation (d) of controlling the mobile massage device from the outside of the mobile massage device when the massage preparation is appropriate, and an operation of determining optimal massage using one or more among operations (a) to (d).

### Second Embodiment of Mobile Massage Device

A mobile massage device according to a second embodiment of the present invention includes two moving parts configured to move the mobile massage device while a position of the mobile massage device is changed, and a massage part that is directly mechanically coupled to the two moving parts and performs a massage service by interlocking with the two moving parts.

A control method of the mobile massage device according to the second embodiment of the present invention includes massage preparation operation (a) of checking power, signals, sensors, and whether a coupling module is used before performing massage with the mobile massage device, massage part operation (b) of performing massage when massage preparation is appropriate, moving part operation (c) of moving the mobile massage device when the massage preparation is appropriate, remote control operation (d) of controlling the mobile massage device from the outside of the mobile massage device when the massage preparation is appropriate, and an operation of determining optimal massage using one or more among operations (a) to (d).

The details of other example embodiments are included in the detailed description and the accompanying drawings.

### BRIEF DESCRIPTION OF THE DRAWINGS

Various aspects will now be described with reference to the accompanying drawings, and similar reference numbers are used to collectively refer to similar components. In the following exemplary embodiments, for description purposes, numerous specific details are set forth in order to provide a thorough understanding of one or more aspects. However, it will be apparent that such aspect(s) can be practiced without these specific details. In other examples, known structures and devices are shown in a block diagram form in order to facilitate describing one or more aspects.

FIG. 1 is a perspective view illustrating a mobile massage device 100 according to a first embodiment of the present invention.

FIG. 2 is a perspective view illustrating a state in which a massage part 120 of the mobile massage device 100 of FIG. 1 is unfolded.

FIG. 3 is a block diagram illustrating an example for describing components of a moving part 110 according to the present invention.

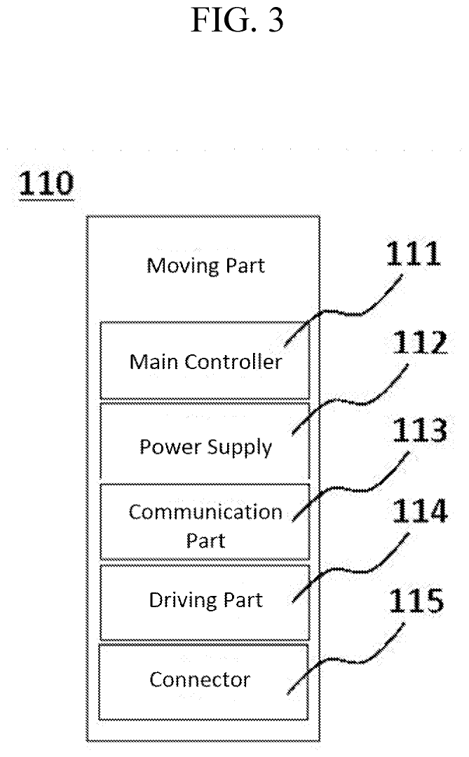

FIG. 4 is a block diagram illustrating an example for describing a control method of mobile massage devices 100, 200 for massage according to the present invention.

FIG. 5 is a perspective view illustrating a mobile massage device 200 according to a second embodiment of the present invention.

FIG. 6 is a perspective view illustrating a state in which a massage part 220 of the mobile massage device 200 of FIG. 5 is unfolded.

FIG. 7 is a block diagram illustrating an example for describing components of a moving part 210 of the mobile massage device 200 according to the present invention.

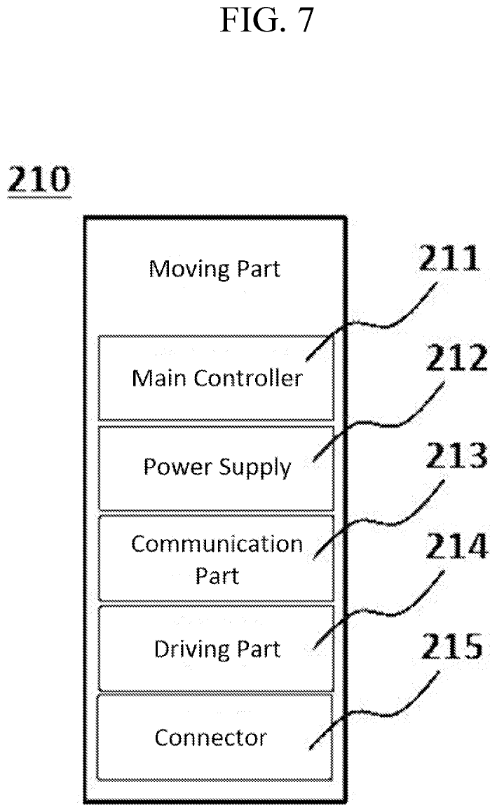

### DETAILED DESCRIPTION

Hereinafter, embodiments disclosed in the present specification will be described in detail with reference to the accompanying drawings. The same reference numerals are given to the same component or similar components regardless of reference numerals, and a repetitive description thereof will be omitted. As used in the following description, the words “module” and “part” for a component are used or interchangeably used solely for ease of preparation of the specification, and do not have different meanings or their own functions. In addition, in the following description of embodiments disclosed herein, when a detailed description of a known related art is determined to obscure the gist of the embodiments disclosed herein, the detailed description thereof will be omitted. In addition, the accompanying drawings are merely for easy understanding of the embodiments disclosed in the present specification, the technical spirit disclosed in the present specification is not limited by the accompanying drawings, and it should be understood to include all modifications, equivalents, and substitutes included in the spirit and scope of the present invention.

Terms including ordinal numbers such as “first,” “second,” and the like used herein may be used to describe various components, but the various components are not limited by these terms. The terms are used only for the purpose of distinguishing one component from another component. When a first component is referred to as being “connected,” or “coupled” to a second component, the first component may be directly connected or coupled to the second component, but it should be understood that a third component may be present between the first component and the second component. Conversely, when a first component is referred to as being “directly connected,” or “directly coupled” to a second component, it should be understood that no other component is between the first component and the second component.

Unless the context clearly dictates otherwise, the singular form includes the plural form.

It should be understood that the terms “comprise,” “include,” and “have” specify the presence of features, numbers, steps, operations, components, elements, or combinations thereof stated herein but do not preclude the presence or possibility of adding one or more other features, numbers, steps, operations, components, elements, or combinations thereof.

In the present specification, an actuator may be a component capable of providing a driving force. For example, the actuator may include a motor, an ultrasonic motor, a linear motor, an electric motor, a DC motor, an AC motor, a linear actuator, an electric actuator, a low-frequency device, a tapping device, a rubbing device, a kneading device, or the like, but the present invention is not limited thereto.

Hereinafter, embodiments of the present invention will be described in detail with reference to the accompanying drawings.

### First Embodiment of Mobile Massage Device

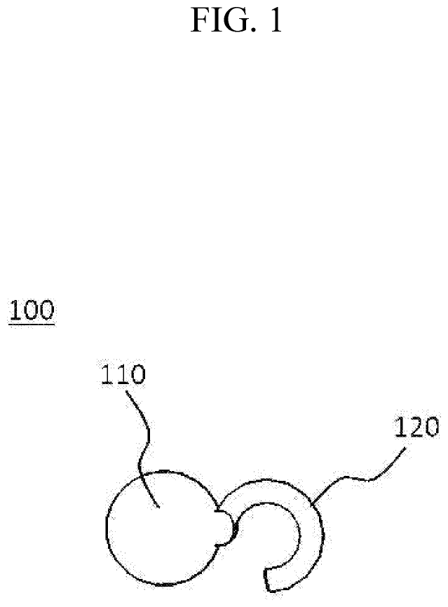

FIG. 1 is a perspective view illustrating a mobile massage device 100 according to a first embodiment of the present invention.

The mobile massage device 100 according to the first embodiment of the present invention includes a moving part 110 that moves the mobile massage device 100 while a position of the mobile massage device 100 is changed, and a massage part 120 that is directly mechanically coupled to the moving part 110, performs a massage service interlocked with the moving part 110, and performs a massage service at one side among front, rear, left, and right sides with respect to a moving direction of the moving part.

The moving part 110 may provide a part for changing a position of the mobile massage device 100 through rotation in order to massage a user's body. The moving part 110 may include a main controller 111 configured to perform integrated management and control on a state, movement, a sensor, communication, multimedia, and an interface of the mobile massage device 100 in order to provide massage while moving in response to a user's request, a power supply 112 configured to perform a battery and power control function of the mobile massage device 100, a communication part 113 configured to transmit and receive an information signal between the mobile massage device 100 and an external control device, a driving part 114 of which a part is an actuator configured to enable rotation of the moving part 110 for position movement of the mobile massage device 100 and a massage operation of the massage part 120 for massaging the user's body, and a connector 115 that allows a connection between the moving part 110 and the massage part 120 using one or more among signal and/or electrical and/or mechanical methods.

The connector 115 may connect the moving part 110 to the massage part 120, and when the moving part 110 rotates, the connector 115 may or may not roll the massage part 120.

The connector 115 may include a button or a display device for a control device (not shown) which allows a user to use the mobile massage device 100. In this case, the display device includes at least one among a liquid crystal display (LCD), a thin-film transistor LCD (TFT LCD), an organic light-emitting diode (OLED) display, a flexible display, or a three-dimensional (3D) display, but the present invention is not limited thereto.

The components included in the moving part 110 are merely exemplary, and the moving part 110 may include various components in addition to the above-described components.

In addition, the shape and structure of the mobile massage device 100 shown in FIG. 1 are merely illustrative, and various types of mobile massage devices 100 may also be included within the scope of the present invention as long as they do not deviate from the scope defined by the appended claims of the present invention.

The moving part 110 may be formed of any material for increasing a frictional force when rotated or include any member (e.g., a non-slip pad or the like or an irregularity structure (not shown)) for increasing a frictional force.

For a bent structure as shown in FIG. 1, the massage part 120 may be formed using one or more joints (not shown), or a method using a soft foam (e.g., silicone, hydrogel, or the like) or a method using a shape memory alloy may be applied to the massage part 120 alone or in a combination thereof.

The massage part 120 may have a structure (not shown) whose length is adjustable depending on the user.

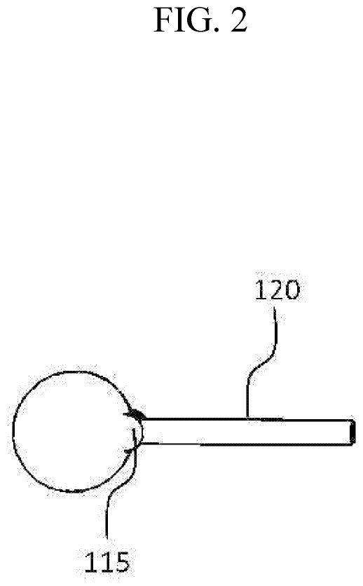

The massage part 120 may be in a bent state as shown in FIG. 1 or in an unfolded state as shown in FIG. 2. Thus, the massage part 120 may perform a massage action such as kneading, rubbing, or tapping a portion of the user's body in a combination method of a bending action and an unfolding action.

The massage part 120 may be formed in the form of joints (not shown) by applying an actuator with a tapping function, a rubbing function, or a kneading function to one or more joints.

The connector 115 may have a structure (not shown) enabling a length of the massage part 120 to change depending on the user.

The mobile massage device 100 may include sensors (e.g., a temperature sensor, a blood pressure sensor, and the like) for obtaining body information of the user, a pressure sensor for detecting a kneading pressure, or the like.

The mobile massage device 100 may include an audio output module (not shown) for a sound output or an audio input module (not shown) for a voice input.

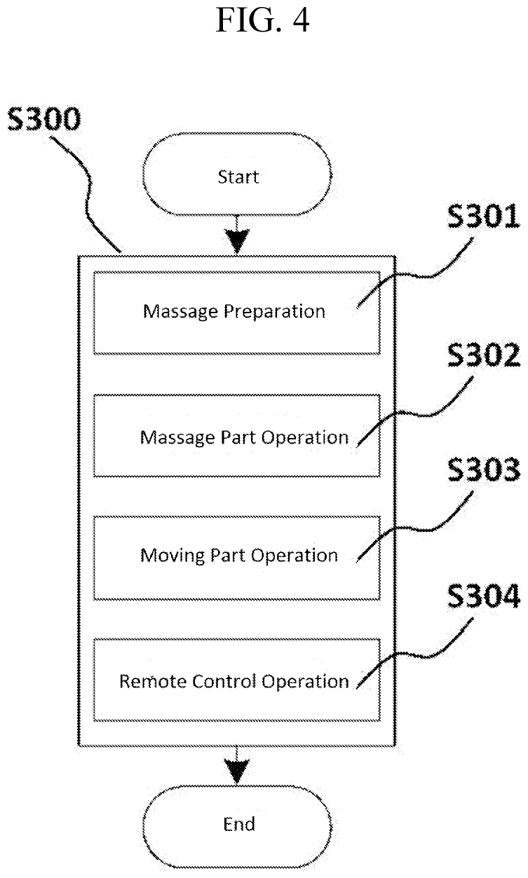

FIG. 4 is a block diagram illustrating an example for describing a control method of the mobile massage device 100 for massage according to the present invention.

In operation S301, before massage is performed with the mobile massage device 100, a power supply, a signal, sensors, a device state, and the like may be checked.

In operation S302, when it is determined that massage preparation is appropriate, an appropriate massage operation may be performed.

In a kneading massage mode, various types of kneading massage may be performed through determination in consideration of durations of operations of bending and unfolding the massage part 120, strength of a bending pressure when the massage part 120 is bent, a change of the length of the massage part 120, or the like.

In a rubbing massage mode, the massage part 120 may be bent in a state suitable for rubbing, and then the moving part 110 may be rotated to move a position of the mobile massage device 100 as much as an appropriate value, or the length of the massage part may be changed to perform massage.

In a tapping massage mode, tapping massage may be performed while adjusting a bending and unfolding time or speed of the massage part 120, or changing the length of the massage part 120 to perform a motion suitable for the tapping massage of the massage part 120.

The tapping massage may be performed by a method in which the massage part 120 is formed using joints (not shown) and includes a device such as an actuator or the like capable of generating vibrations in the joints.

In operation S303, when it is determined that the massage preparation is appropriate, the moving part 110 is rotated to move the mobile massage device 100.

In operation S304, when it is determined that the massage preparation is appropriate, a remote control operation may be performed at the outside of the mobile massage device 100 so that a movement speed, massage strength, and a massage mode of the mobile massage device 100 may be selected directly or using a voice command or the like through a remote control device (not shown).

The remote control device (not shown) of the mobile massage device 100 may include a remote controller, a cellular phone, a personal digital assistant (PDA), or the like, but the present invention is not limited thereto, and the remote control device may include any of various electronic devices connectable to the mobile massage device 100 through wired or wireless communication.

In operation S300, by using one or more among operations S301 to S304, optimal motions for the tapping massage mode, the rubbing massage mode, the kneading massage mode, and the like may be determined to perform massage on the user's body.

A method of selecting a massage mode or setting an environment of the mobile massage device 100 may include one or more among manual, automatic, and remote control methods.

### Second Embodiment of Mobile Massage Device

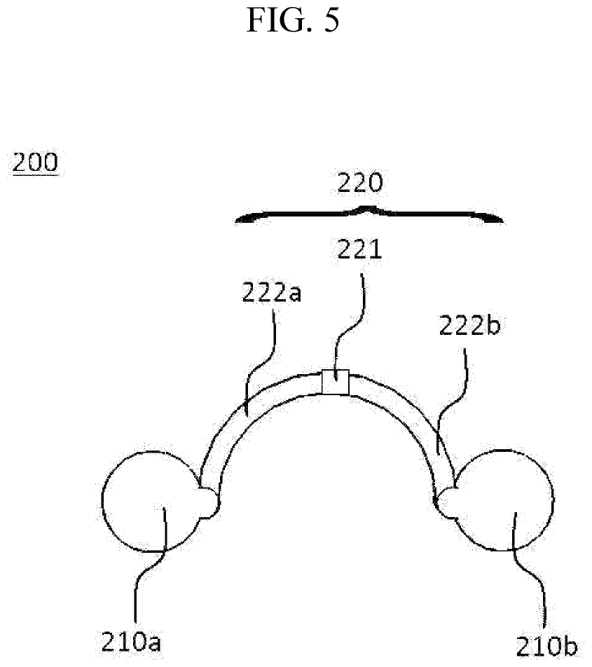

FIG. 5 is a perspective view illustrating a mobile massage device 200 according to a second embodiment of the present invention.

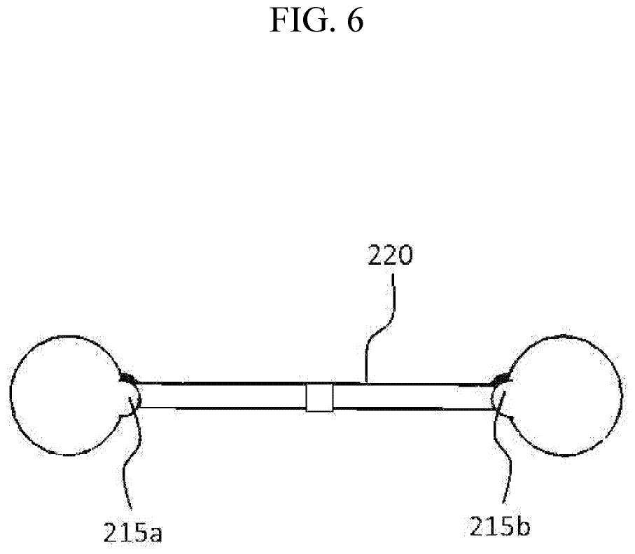

FIG. 6 is a perspective view illustrating a state in which a massage part 220 of the mobile massage device 200 of FIG. 5 is unfolded.

The mobile massage device 200 according to the second embodiment of the present invention includes moving parts 210a and 210b configured to move the mobile massage device 200 while a position of the mobile massage device 200 is changed, and a massage part 220 that is directly mechanically coupled to the moving parts 210a and 210b and performs a massage service by interlinking with the moving parts 210a and 210b.

The moving parts 210a and 210b may provide parts for changing a position of the mobile massage device 200 in order to massage the user's body through rotation. The moving parts 210a and 210b may include a main controller 211 configured to perform integrated management and control on a state, movement, a sensor, communication, multimedia, an interface of the mobile massage device 200, and the like in order to provide massage while moving in response to a user's request, a power supply 212 which performs a battery and power control function of the mobile massage device 200, a communication part 213 configured to transmit and receive an information signal between the mobile massage device 200 and an external control device, a driving part 214 of which a part is an actuator configured to enable rotation of the moving parts 210a and 210b for position movement of the mobile massage device 200 and a massage operation of the massage part 220 for massaging the user's body, and connectors 215a and 215b that allow connections between the moving parts 210a and 210b and the massage part 220 using one or more among signal and/or electrical and/or mechanical methods.

The connectors 215a and 215b may connect the moving parts 210a and 210b to the massage part 220, and when the moving part 110 is rotated, the connectors 215a and 215b may or may not roll the massage part 220.

The connectors 215a and 215b may each include a button, a display device, or the like for a control device (not shown) which allows a user to use the mobile massage device 200. In this case, the display device includes at least one among an LCD, a TFT LCD, an OLED display, a flexible display, or a three-dimensional (3D) display, but the present invention is not limited thereto.

The components included in the moving parts 210a and 210b are merely exemplary, and the moving parts 210a and 210b may include various components in addition to the above-described components.

In addition, the shape and structure of the mobile massage device 200 shown in FIG. 5 are merely illustrative, and various types of mobile massage devices 200 may also be included within the scope of the present invention as long as they do not deviate from the scope defined by the appended claims of the present invention.

The moving parts 210a and 210b may be formed of any material for increasing a frictional force when rotated or include any member (e.g., a non-slip pad or the like or an irregularity structure (not shown)) for increasing a frictional force.

For a bent structure as shown in FIG. 5, the massage part 220 may be formed using one or more joints (not shown), or a method using a soft foam (e.g., silicone, hydrogel, or the like) or a method using a shape memory alloy may be applied to the massage part 120 alone or in a combination thereof.

The massage part 220 may have a structure (not shown) whose length is adjustable depending on the user.

The massage part 220 may have a structure not using the coupling module 221 or a structure including two or more massage part modules using one or more coupling modules 221.

The coupling module 221 may connect one massage part module 222a and the other massage part module 222b using one or more among signal and/or electrical and/or mechanical methods.

The massage part 220 may be formed in the form of joints (not shown) by applying an actuator with a tapping function, a rubbing function, or a kneading function to one or more joints.

The massage part 220 may be in a bent state as shown in FIG. 5 or in an unfolded state as shown in FIG. 6. Thus, the massage part 120 may perform a massage action such as kneading, rubbing, or tapping a portion of the user's body combining a bending action and an unfolding action.

The connectors 215a and 215b may each have a structure (not shown) enabling a length of the massage part 220 to change depending on the user.

The mobile massage device 200 may include sensors (e.g., a temperature sensor, a blood pressure sensor, and the like) for obtaining body information of the user, a pressure sensor for detecting a kneading pressure, or the like.

The mobile massage device 200 may include an audio output module (not shown) for a sound output or an audio input module (not shown) for a voice input and the like.

FIG. 4 is a block diagram illustrating an example for describing a control method of the mobile massage device 200 for massage according to the present invention.

In operation S301, before massage is performed with the mobile massage device 200, a power supply, a signal, sensors, whether a coupling module is used, and device states, and the like may be checked.

In operation S302, when it is determined that massage preparation is appropriate, an appropriate massage operation may be performed.

In a kneading massage mode, various types of kneading massage may be performed through determination in consideration of durations of operations of bending and unfolding the massage part 220, strength of a bending pressure when the massage part 120 is bent, and the like.

In the kneading massage mode, a distance between the two moving parts becomes shorter due to cooperation and operations of the moving part 210a and the moving part 210b, and as the massage part is bent or the length of the massage part is changed, massage is performed on a portion of the body in close contact with the massage part.

In a rubbing massage mode, the massage part 220 may be bent in a state suitable for rubbing, and then the moving parts 210a and 210b may be rotated to move a position of the mobile massage device 200 as much as an appropriate value, or the length of the massage part may be changed to perform massage.

In a tapping massage mode, tapping massage may be performed while adjusting a bending and unfolding time, a speed, or the like of the massage part 220, or changing the length of the massage part 220 to perform a motion suitable for the tapping massage of the massage part 120.

The tapping massage may be performed by a method in which a massage part module 222a and a massage part module 222b, which constitute the massage part 220, are formed using joints (not shown) and include a device such as an actuator or the like capable of generating vibrations in the joints.

In operation S303, when it is determined that the massage preparation is appropriate, the moving parts 210a and 210b rotate to move the mobile massage device 200.

In operation S304, when it is determined that the massage preparation is appropriate, a remote control operation may be performed at the outside of the mobile massage device 200 so that a movement speed, massage strength, a massage mode, and the like of the mobile massage device 200 may be selected directly or using a voice command or the like through a remote control device (not shown).

The remote control device (not shown) of the mobile massage device 200 may include a remote controller, a cellular phone, a PDA, or the like, but the present invention is not limited thereto, and the remote control device may include any of various electronic devices connectable to the mobile massage device 200 through wired or wireless communication.

In operation S300, by using one or more among operations S301 to S304, optimal motions for the tapping massage mode, the rubbing massage mode, the kneading massage mode, and the like may be determined to perform massage on the user's body.

In operation S300, the mobile massage device 200 may perform cooperative control on the movement between the moving part 210a and the moving part 210b in a manner suitable for the massage mode.

In operation S300, the motions of the massage part module 222a and the massage part module 222b, which constitute the massage part 220, may be cooperatively controlled in a manner suitable for the massage mode.

A method of selecting a massage mode or setting an environment of the mobile massage device 200 may include one or more among manual, automatic, and remote control methods.

In accordance with a mobile massage device and a method for controlling same according to the present invention, one or more effects can be provided.

First, there is an advantage of being able to massage while moving a moving part.

Second, there is an advantage of being able to massage by operating the massage part.

Third, there is an advantage that massage can be performed by operating the massage part while moving the moving part.

It should be noted that effects of the present invention are not limited to the above-described effects, and other effects that are not described will be apparent to those skilled in the art from the appended claims.

Those skilled in the art will appreciate that the present invention can be implemented in combination with other program modules and/or in a combination of hardware and software and/or in a combination of mechanical parts.

Those skilled in the art to which the present invention pertains can understand that various illustrative logical blocks, modules, processors, parts, circuits, and algorithm operations described in connection with the embodiments disclosed herein can be implemented by electronic hardware, programs or design codes in various forms (for convenience, referred to as software herein), or a combination thereof. To clearly describe the interchangeability of hardware and software, various exemplary components, blocks, modules, circuits, and operations have been described above generally in terms of their functions. Whether these functions are implemented as hardware or software depends on a particular application and design constraints imposed on the overall system. Those skilled in the art can implement the functions described in various ways for each particular application, but such implementation decisions should not be construed as departing from the scope of the present invention.

Various embodiments disclosed herein can be implemented as a method, an apparatus, or an article using standard programming and/or engineering techniques. The term “article” includes a computer program, a carrier, or a media accessible from any computer-readable device. For example, computer-readable storage media include magnetic storage devices (e.g., hard disks and the like), solid state disks (SSDs), silicon disk drives (SDDs), smart cards, or flash memory devices (e.g., electrically erasable and programmable read only memories (EEPROMs), cards, sticks, or the like), but the present invention is not limited thereto.

It should be understood that the specific order or hierarchical structure of operations in the proposed processes is an example of exemplary approaches. On the basis of design priorities, it should be understood that the specific order or hierarchical structure of operations in the processes can be rearranged without departing from the scope of the present invention. The appended method claims present elements of the various operations in a sample order, but are not meant to limit them to the proposed specific order or hierarchical structure.

The descriptions of the above embodiments are provided to allow those skilled in the art to use or practice the present invention. Various modifications to these embodiments will be apparent to those skilled in the art, and the general principles defined herein can be applied to other embodiments without departing from the scope of the present invention. Thus, the present invention is not limited to the embodiments disclosed herein but is to be construed in the widest scope consistent with the principles and novel features disclosed herein.

### DESCRIPTION OF REFERENCE NUMERALS

100: Body according to first embodiment
110: Moving part
115: Connector
120: Massage part
200: Body according to second embodiment
210 (210a, 210b): Moving part according to second embodiment
220 (221, 222a, 222b): Massage part according to second embodiment
221: Coupling module according to second embodiment
222a and 222b: Massage part module according to second embodiment

What is claimed is:

1. A mobile massage device comprising:
a moving part configured to move the mobile massage device while a position of the mobile massage device is changed; and
a massage part mechanically directly coupled to the moving part and configured to perform a massage service interlocked with the moving part and perform a massage service at one side among front, rear, left, and right sides with respect to a moving direction of the moving part,
wherein, through a control method of the mobile massage device, at least one massage motion among a kneading massage mode, a rubbing massage mode, and a tapping massage mode for a portion of a user's body is performed.

2. The mobile massage device of claim 1, wherein the moving part includes:
a main controller configured to provide a part to change a position of the mobile massage device in order to provide massage on the user's body and perform integrated management and control on a state, movement, a sensor, communication, multimedia, an interface of the mobile massage device in order to provide massage while moving in response to the user's request;
a power supply which performs a battery and power control function of the mobile massage device;
a communication part configured to transmit and receive an information signal between the mobile massage device and an external control device;
a driving part of which a part is an actuator by which the moving part for position movement of the mobile massage device is rotated and a massage operation of the massage part for massaging the user's body is performed; and
a connector that allows a connection between the moving part and the massage part using one or more among signal and/or electrical and/or mechanical methods.

3. The mobile massage device of claim 2, wherein the connector has a structure configured to or not to roll the massage part when the moving part is rotated.

4. The mobile massage device of claim 1, wherein the massage part has a structure that is unfolded or bent.

5. The mobile massage device of claim 1, wherein the massage part has a structure that is formed using one or more joints for a bent structure or to which a method using a soft foam or a method using a shape memory alloy is applied alone or in a combination thereof.

6. The mobile massage device of claim 1, wherein the massage part has a structure to which an actuator with one or more among a tapping function, a rubbing function, and a kneading function with respect to one or more joints is applied in a form in which the massage part is formed using joints.

7. The mobile massage device of claim 1, wherein the massage part has a structure whose length is adjustable depending on the user.

8. The mobile massage device of claim 1, wherein the control method of the mobile massage device includes:
massage preparation operation (a) of checking power, signals, sensors, and a device state before performing massage with the mobile massage device;
massage part operation (b) of performing massage when massage preparation is appropriate;
moving part operation (c) of moving the mobile massage device when the massage preparation is appropriate;
remote control operation (d) of controlling the mobile massage device from outside of the mobile massage device when the massage preparation is appropriate; and
an operation of determining optimal massage using one or more among operations (a) to (d).

9. The mobile massage device of claim 1, wherein, in a kneading massage mode, various types of kneading massage are performed through determination in consideration of durations of operations of bending and unfolding the massage part, strength of a bending pressure when the massage part is bent, a change of a length of the massage part.

10. The mobile massage device of claim 1, wherein, in a rubbing massage mode, the massage part is bent in a state suitable for rubbing, and then a position of the mobile massage device moves as much as an appropriate value, or a length of the massage part is changed to perform massage.

11. The mobile massage device of claim 1, wherein, in a tapping massage mode, tapping massage is performed while adjusting a bending and unfolding time or speed of the massage part, changing a length of the massage part to perform a motion suitable for the tapping massage of the massage part, or using a method in which the massage part is formed using joints and has an actuator device for generating vibrations at the joints.

12. A mobile massage device comprising:
two moving parts provided at both ends of the mobile massage device and configured to move the mobile massage device while changing a position of the mobile massage device; and
a massage part that is directly mechanically coupled to the two moving parts and performs a massage service by interlocking with the two moving parts,
wherein, through a control method of the mobile massage device, at least one massage motion among a kneading massage mode, a rubbing massage mode, and a tapping massage mode for a portion of a user's body is performed.

13. The mobile massage device of claim 12, wherein the moving part includes:
a main controller configured to provide a part to change a position of the mobile massage device in order to provide massage on the user's body and perform integrated management and control on a state, movement, a sensor, communication, multimedia, an interface of the mobile massage device in order to provide massage while moving in response to the user's request;
a power supply which performs a battery and power control function of the mobile massage device;
a communication part configured to transmit and receive an information signal between the mobile massage device and an external control device;
a driving part of which a part is an actuator by which the moving part for position movement of the mobile massage device is moved and a massage operation of the massage part for massaging the user's body is performed; and
a connector that allows a connection between the moving part and the massage part using one or more among signal and/or electrical and/or mechanical methods.

14. The mobile massage device of claim 13, wherein the connector has a structure configured to or not to roll the massage part when the moving part is rotated.

15. The mobile massage device of claim 12, wherein the massage part has a structure that is unfolded or bent.

16. The mobile massage device of claim 12, wherein the massage part has a structure that is formed using one or more joints for a bent structure or to which a method using a soft foam or a method using a shape memory alloy is applied alone or in a combination thereof.

17. The mobile massage device of claim 12, wherein the massage part has a structure in which a coupling module is not used or two or more massage part modules are coupled using one or more coupling modules.

18. The mobile massage device of claim 12, wherein the massage part has a structure to which an actuator with one or more among a tapping function, a rubbing function, and a kneading function with respect to one or more joints is applied in a form in which the massage part is formed using joints.

19. The mobile massage device of claim 12, wherein the massage part has a structure whose length is adjustable depending on the user.

20. The mobile massage device of claim 17, wherein the coupling module has a structure for connecting one massage part module and other massage part module using one or more among signal and/or electrical and/or mechanical methods.

21. The mobile massage device of claim 12, wherein the control method of the mobile massage device includes:
massage preparation operation (a) of checking power, signals, sensors, and whether a coupling module is used before performing massage with the mobile massage device;
massage part operation (b) of performing massage when massage preparation is appropriate;
moving part operation (c) of moving the mobile massage device when massage preparation is appropriate;
remote control operation (d) of controlling the mobile massage device from outside of the mobile massage device when the massage preparation is appropriate; and
an operation of determining optimal massage using one or more among operations (a) to (d).

22. The mobile massage device of claim 12, wherein, in a kneading massage mode, various types of kneading massage are performed with cooperation of two moving parts through determination in consideration of durations of operations of bending and unfolding the massage part, strength of a bending pressure when the massage part is bent, a change of a length of the massage part.

23. The mobile massage device of claim 12, wherein, in a rubbing massage mode, the massage part is bent in a state suitable for rubbing, and then a position of the mobile massage device moves as much as an appropriate value, or a length of the massage part is changed to perform massage.

24. The mobile massage device of claim 12, wherein, in a tapping massage mode, tapping massage is performed while adjusting a bending and unfolding time or speed of the massage part, changing a length of the massage part to perform a motion suitable for the tapping massage of the massage part, or using a method in which the massage part is formed using joints and has an actuator device for generating vibrations at the joints.
